(19) United States
(12) Patent Application Publication
(10) Pub. No.: US 2021/0252377 A1
(43) Pub. Date: Aug. 19, 2021

(54) SYSTEM AND METHODS FOR GAMIFICATION OF BINGO

(71) Applicant: GeoPlay, Inc., Altadena, CA (US)

(72) Inventors: Sam Calis, Pasadena, CA (US); Joseph O Pearce, JR., Costa Mesa, CA (US); Janet Amemiya, Pasadena, CA (US)

(73) Assignee: GeoPlay, Inc.

(21) Appl. No.: 17/180,117

(22) Filed: Feb. 19, 2021

Related U.S. Application Data
(60) Provisional application No. 62/978,679, filed on Feb. 19, 2020.

(51) Int. Cl. A63F 3/06; A63F 13/35

(52) U.S. Cl. CPC A63F 3/0645; A63F 13/35

(57) ABSTRACT

A game simulation based on the game of bingo is provided as a service by a server computer with which game servers can communicate and offers methods to create, operate, and return results of bingo games. Objects that conform to predefined data formats and represent components and operators of bingo games can be transmitted between game servers and the service and store these objects in association with the operators. Thus, the game server can use the service and its bingo game simulations to resolve the chance and related skill events in the game server's game environment with methods compliant with Class II Gaming.

### CROSS REFERENCE TO RELATED APPLICATIONS

The present application claims the benefit under 35 U.S.C. 119 of U.S. Provisional Patent Application Ser. No. 62/978,679 filed Feb. 19, 2020. The U.S. Provisional Patent Application Ser. No. 62/978,679 is hereby incorporated by reference in its entirety

### BACKGROUND OF THE INVENTION

### Field of the Invention

The present specification relates to systems and method for gamification of bingo, more particularly turning any type of video game into bingo by relating bingo cards and numbers to objects in a game.

### Description of Related Art

The present invention relates to a gaming system wherein a game server communicates through a computer network with a number of users who make choices in wagers and performing actions which are operated upon to determine winners among the users based on a set of defined rules of chance and/or skill.

The developers of such a gaming system may find themselves required to comply with regulations of a gaming commission or other authority. One such set of regulations applies to Class II Gaming, which is the game of chance commonly known as bingo and similar games like pull tabs, punch board, and other games like bingo. Bingo is a well-known and common game, but the principles of the bingo game may be presented in several different graphical depictions. It is desirable to have a game that is more visually compelling than traditional bingo, but still fitting within the regulatory structure of the common bingo game. Having access to systems, methods, and virtual objects to operate bingo games in a regulatory compliant manner is desirable.

### BRIEF SUMMARY OF THE INVENTION

A gaming system can, in general, use any set of rules to determine the odds of a particular user winning on a wager, and may set additional rules for other actions that must be completed to fulfill the conditions for winning; i.e., a skill-based component of the game. For the sake of comprehension by users, these rules and conditions would be explained as analogous to real-world objects that are represented by virtual objects within the game system. A gaming system that operates over a computer network that is located within a Casino or other type of establishment can have one or more computers that constitute a game server and are responsible for determining winners of events. The game server would utilize either a local or remote set of components that performs the process of winner determination using a random number generator applied to the probabilities derived from the attributes of the game's virtual objects.

If the game system is to be employed for real-money wagering, compliance with the rules of a gaming commission or other authority are nominally required. Compliance can be a complex, time-consuming, and expensive process if the game has wagers on events involving an arbitrary set of virtual objects. The process can be simplified by choosing well-known objects (virtual or real-world) that gaming commissions already consider acceptable for the basis of wagering, one of which is the game of bingo.

In one embodiment, the above and other objects are accomplished through devices including a game simulation system. A Non server associates at least one bingo-style card with a game instance object that is itself associated with a graphical depiction of the game that does not include a depiction of a bingo-style card. Instead, the graphical depiction may be a horse race, a first-person shooter game, a space invaders type game or other graphical depiction.

A random number generator generates a list of unique random numbers that are used as a ball drop, selecting the numbers used with the bingo-style cards to determine a winner or winners. The ball drop may assign numbers to a graphical object in the game and the user plays the number associated with the graphical object by interacting with the graphical object in the game.

The random number generator may produce cryptographically-strong sequences of unique random numbers within a specified numerical range. In another embodiment, the bingo-style card is assigned numbers by the random number generator or through user selection of numbers.

A game server is connected to the math server and is also connected to at least one user terminal through a computer network such as the internet. Each bingo-style card is associated with a user and the game server displays the graphical depiction of the game to the user on the user terminal. The math server and the game server may be a single server or may be separated from each other and in network communication. Access to the game server may be restricted by, for example, the geographical location of the user or the user terminal. The bingo-style card can have a plurality of attributes such as, for example, a count of columns, a count of rows, location of free spaces, a range of numbers that can appear in non-free spaces, and whether numbers in spaces are unordered or ordered.

In another embodiment of the invention, a game administration system is provided. A math server again links at least one bingo-style card with a game instance object that is associated with a graphical depiction of the game that does not include a depiction of a bingo-style card. A random number generator may provide a list of unique random numbers that are used as a ball drop and the math server performs a bingo game using the at least one bingo-style card and ball drop to determine winners.

A computer terminal provides a game configuration editor that allows an administrator to access a game configuration. The game configuration defines a plurality of attributes of the bingo game selected from the list consisting of a format of the bingo-style car, the number of players allowed for a bingo game, the graphical depiction of the bingo game, the way progress in the bingo game is displayed through the graphical depiction of the bingo game, the maximum amount of money that can be wagered on the bingo game, the type of results that users can place wagers upon, the conditions for winning the bingo game, the geographical area in which the game may be played, and network protocols to allow access to the bingo game. An administrator interface generated by the game configuration editor allows the administrator to create, edit and view game configurations stored in the bingo math server.

The graphical depiction of the game can be edited to resemble a horse race where progress in the bingo game is correlated with progress in the horse race. Alternatively, the graphical depiction of the game could be a first person shooter where characters in a game are assigned numbers, and the user can play that number when they shoot the character in the game. Many variations where the ball drop assigns numbers to a graphical object in the game and the user plays the number associated with the graphical object by interacting with the graphical object in the game may be chosen by an administrator through the game configuration editor.

The administrator may change a number of attributes of the bingo-style card such as, for example, a count of columns, a count of rows, location of free spaces, a range of numbers that can appear in non-free spaces, and whether numbers in spaces are unordered or ordered. In a particular embodiment, the administrator may determine that the bingo-style card is assigned numbers by the random number generator or through user selection of numbers.

In another embodiment of the invention, a method is provided for running a bingo-style game. A bingo-style card linked to a game instance object is associated with a graphical depiction of the game that does not include a depiction of a bingo-style card. A random number generator is provided that generates a list of unique random numbers and the list of unique numbers is used as a ball drop, determining the winner(s) of the game. A depiction of the game is displayed to users on at least one user terminal.

The graphical depiction of the game may be a horse race and progress in the bingo game is correlated with progress in the graphical depiction of the horse race. Numbers may be assigned to the graphical object in the game based on the ball drop allowing the user to play the number associated with the graphical object by interacting with the graphical object in the game. Access to the game may be restricted to a defined geographical area.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a block diagram for explaining the outline of the construction of the game-server-facing embodiment of the present invention;

FIG. 2 is a diagram showing examples of the format of object data stored in the bongo math service database;

FIG. 3 is a diagram showing examples of five possible formats of bingo cards encodable in data objects; and

FIG. 4 is a block diagram for explaining the outline of the construction of the game-administration-facing embodiment of the present invention.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

An embodiment of the present invention will be described in detail with reference to the drawings. In this example, there will be exemplified the mode in which a wagerable game environment is generated on a server computer, and in which, using a terminal computer, each user places a wager and the success of event wagered upon is resolved by the server computer communicating with an application on another computer system with an embodiment of the present invention. The description below uses some terminology specific to the game of bingo that will defined here. “Ball drop” is the act of selecting a sequence of unique random numbers from a range, where the term comes from the selection process in a physical game of using numbered balls. “Daub” is the act of marking a space on a bingo card when the number in that space matches a ball drawn.

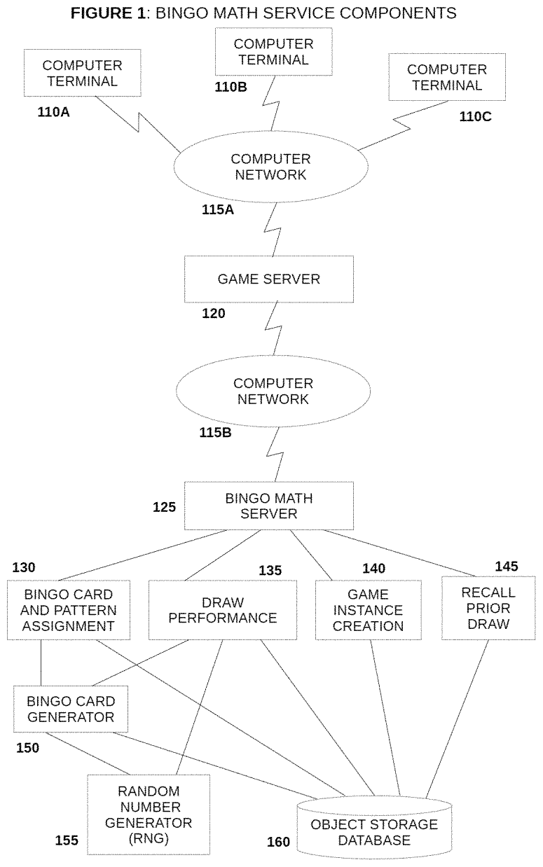

Referring initially to FIG. 1, a block diagram is provided showing the outline of the construction of a service portion. A plurality of terminal computers 110A, 110B, 110C can be connected to a game server 120 through a network 115A such as the Internet. Access to the game server can be controlled by determining whether the terminal computers 110A, 110B, 110C are within a general area or location using, for example, geolocation, geospatial block, magnetic positioning, Wi-Fi Triangulation, Bluetooth, beacons, or the like. A terminal computer 110A, 110B, 110C can be a mobile computing device, laptop, personal computer, or the like. Users can access the game server 120 by using their respective terminal computers 110A, 110B, 110C, wherein the users can participate in a game environment generated on the server computer 120. The game server 120 can present events in the game environment on terminal computers 110A, 110B, 110C which have several possible results that users can place wagers upon.

The game environment on the game server 120 has been designed to meet Class II game compliance that is required by the Indian Gaming Regulatory Act which can delegate elements of event resolution by interfacing with a Bingo Math Server 125 through a computer network 115B such as the Internet or a private intranet. The Bingo Math Server 125 provides network protocols to allow access to the information processing units and the virtual objects manipulated by the functional units. The computer-network-facing 115B component of the Service is the Bingo Math Server 125 which processes incoming requests from the game server 120 and then routes the requests to the appropriate information processing unit.

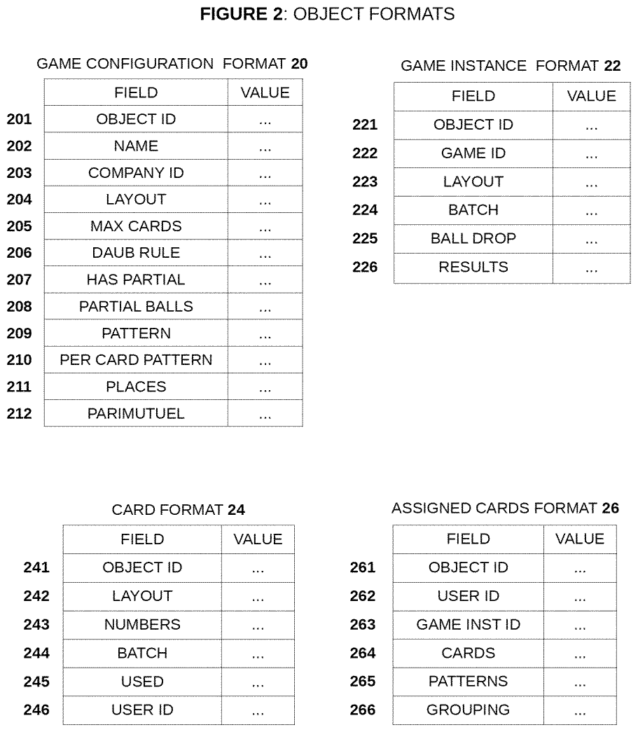

The information processing units will manufacture virtual objects representing the bingo game environment simulated by the Bingo Math Server 125. Examples of the format of virtual objects is given in FIG. 2 and described below. A game configuration object 20 may have some combination of the following fields: object ID 201, name 202, company ID 203 (used to authenticate the game server 120), bingo card layout 204, maximum number of bingo cards needed for a game 205, daub rule 206, a flag indicating if partial draws are allowed 207, count of balls in a partial draw 208, the default patterns to match to win 209, a flag indicating if each bingo card can have alternate patterns from the default 210, the total number of final pattern winners 211, and a flag indicating the game has pari-mutuel wagering 212. Additional details on some of these fields are provided below.

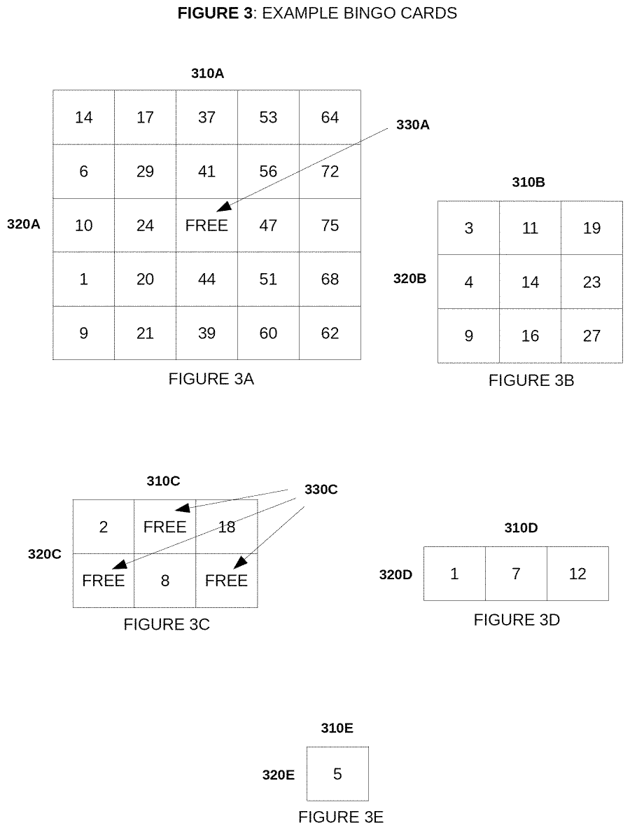

Referring in particular to FIG. 3 a diagram is provided depicting a visual representation of a bingo card layout 204, 223, 242. FIG. 3A is a “standard” bingo card with the layout attributes of 5 columns 310A, 5 rows 320A, one free space in the center 330A, 75 possible numbers in spaces, and unordered numbers per column. FIG. 3B is a variant bingo card with layout attributes of 3 columns 310B, 3 rows 320B, no free spaces, 27 possible numbers in spaces, and ordered numbers per column. FIG. 3C through 3E are other variant bingo cards with various layout attributes of number of columns 310C, 310D, 310E, rows 320C, 320D, 320E, and free spaces 330D.

The daub rule 206 is an attribute of the game environment that has three modes such as auto-daub, manual daub, and skill daub. An example environment with auto-daub can operate to determine a winner without the user's interaction. Manual daub gives the user an option to perform daubs by interacting with the display on their terminal computer 110. Skill daub requires the user to perform the daubs.

Referring to FIG. 2 a game instance object 22 is providing showing one example of format fields such as object ID 221, game configuration ID 222, bingo card layout 223, bingo card batch 224, ball drop 225, and game results 226. A bingo card object 24 can have the a number of fields such as, for example, object ID 241, bingo card layout 242, numbers 243, bingo card batch 244, used flag 245, and user ID when used 246. An assigned card object 26 can have fields such as, for example, object ID 261, user ID 262, game instance ID 263, list of bingo card IDs 264, list of patterns assigned to cards 265, and pari-mutuel group (if any) 266.

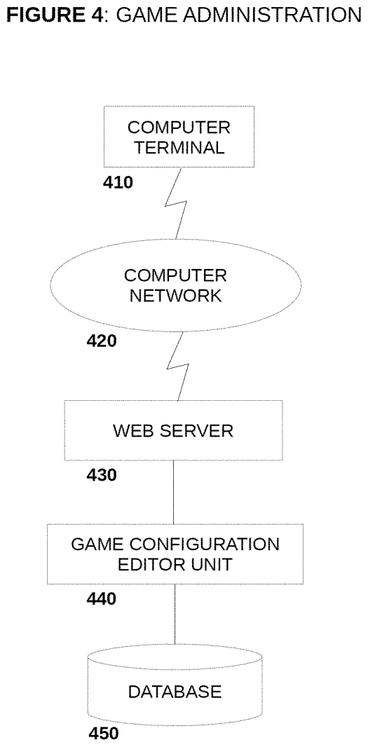

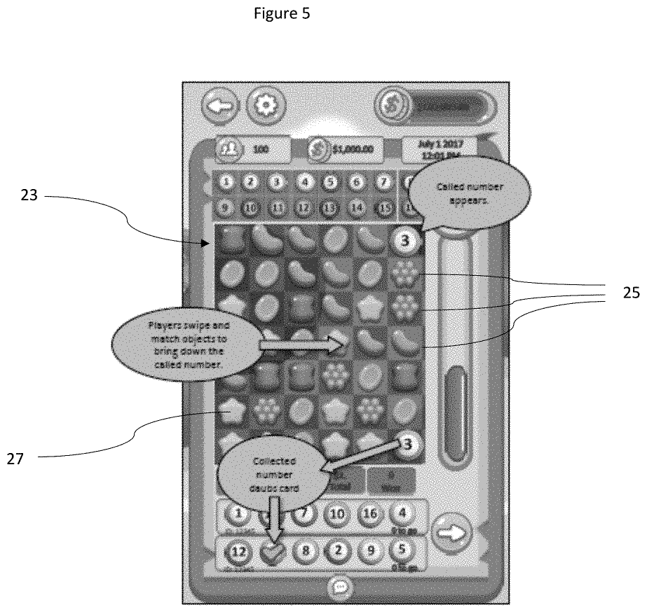

Referring to FIG. 1 and FIG. 2, although the exact order of requests can vary, the first step for the example game is for the game server 120 to send a message to the Bingo Math Server 125 requesting the creation of a new game instance object 22, The message is routed to the Game Instance Creation Unit 140, which retrieves the game configuration object 20 from the Object Storage Database 160 corresponding to the object ID 201 provided in the message, creates a game instance object 22 from the retrieved data, stores the new object back in the database, and routes it back to the server to send as a response. The game configuration object 20 must have been previously stored in the database by the Game Configuration Editor Unit 440 (see FIG. 4) to be described later.

The game server 120 will provide an interactive display to terminal computers 110A, 110B, 110C allowing users to select an upcoming game instance and place a wager on, for example, a horse. A wager must be linked to a bingo card, which is operated by sending a message to the Bingo Math Server 125 requesting that a bingo card object 24 be assigned to the user. The message is routed to the Bingo Card and Pattern Assignment Unit 130, which then retrieves the game instance object 22 corresponding to the one selected by the user and game configuration object 20 matching the game ID 222 value from the Object Storage Database 160, fetches an unused bingo card from the Bingo Card Generator Unit 150 (details in next paragraph) matching the layout 223 and batch 224 values, creates a new assigned cards object 26 from the collected data, stores the new object back in the database, and also routes it back to the server to send as a response. In this example default pattern 209 for the game configuration 20 is assigned to each card, but a more complicated horse race that assigns each horse different odds could provide alternate patterns 265 values in the above request message to be placed in each assigned card object 26.

The numbers of the bingo card are associated with a spatial position of a graphical horse presented to the user(s) on terminal computers 110A, 110B, 110C. As numbers are selected that match the user's bingo card moving the user closer to a win, the horse is shown to progress on the racetrack. Different user's in a particular game may view the same graphical representation of the game or may each view a different graphical representation selected based on the user's preference.

The Bingo Card Generator Unit 150 can operate in one of two modes to generate card objects 24 such as pre-generating and on-demand, with the mode determined by the layout 242 of the cards. In both cases the Random Number Generator 155 can be queried to create a list of random numbers based on the components of the layout as described in the paragraph about FIG. 3 above. An attempt is made to store this unused 245 card format 24 in Object Storage Database 160, but is rejected if the uniqueness requirement for cards in a batch 244 is not met. A new batch may be started in the case of rejection, and the object stored in that batch. When another unit 130, 135 requests an unused card with a particular layout 242, the game can allow the user to choose the numbers that appear in the card object 24 which is then stored in the the Object Storage Database 160 without any requirement of uniqueness or starting a new batch.

At the time determined by the game server 120, it can send a message to the Bingo Math Server 125 to request a bingo game to be operated to resolve, for example, a horse race represented by a game instance object 22 with object id 221. The message is routed to the Draw Performance Unit 135, which retrieves all bingo card objects 24 of all users with assigned cards objects 26 matching game instance id 263 from the Object Storage Database 160, uses the Random Number Generator 155 to generate a list of unique random numbers as the ball drop, performs a bingo game using the cards, patterns and ball drop to determine winners, modifies the ball drop 225 and results 226 values of the game instance object 22 and stores it back in the database, and also routes it back to the server to send as a response. The game server 120 can then provide a display with a representation of, for example, the horse race on terminal computers 110A, 110B, 110C.

The game server 120 can support a replay feature of a race for a terminal computer 110 by sending a message to the Bingo Math Server 125 with the object id 221 to replay. The message is routed to the Recall Prior Draw Unit 145, which retrieves the matching game instance object 22 from the Object Storage Database 160 and returns it to the server.

Referring to FIG. 4 showing a block diagram of a game administration system wherein the game administration system can comprise a computer terminal 410 with a web browser application which can connect to a web server 430 through a computer network 420 such as the Internet. The web server 430 provides a user interface generated by the game configuration editor unit 440 to be displayed on the display screen of the computer terminal 410 that allows viewing, creation and editing of the game configurations stored in the database 450 of the Bingo Math Service.

An embodiment of a game environment using the Bingo Match Service can be horse racing game wherein the user can log into the game and choose at least one horse to win a race. Each horse is assigned a Bingo card, as shown in FIG. 3, wherein the user can purchase the horse that the Bingo card is assigned to that the user thinks will win the race. When the race starts a Random Number Generator 155 generates numbers that are on the Bingo cards wherein the winning horse has the winning Bingo card. Another embodiment is a first-person shooter game wherein each character within the game is assigned a random number and the user is assigned a random Bingo card. When the game begins the user shoots at each character and when that character is eliminated the number associated with that character is daubed on the Bingo card until the user daubs a complete row, column or other combination to call Bingo.

We claim:

1. A game simulation system, comprising:
a math server that associates at least one bingo-style card associated with a game instance object that is associated with a graphical depiction of the game that does not include a depiction of a bingo-style card, and that has a random number generator that generates a list of unique random numbers that are used as a ball drop, wherein the math server performs a bingo game using the at least one bingo-style card and ball drop to determine winners;
a game server coupled to the math server and coupled to at least one user terminal through a computer network wherein each bingo-style card is associated with a user and the game server displays the graphical depiction of the game to the user on the at least one user terminal.

2. The system of claim 1 wherein the math server and the game server are a single server.

3. The system of claim 1 wherein the graphical depiction of the game is a horse race and wherein progress in the bingo game is correlated with progress in the graphical depiction of the horse race.

4. The system of claim 1 wherein the ball drop assigns numbers to a graphical object in the game and the user plays the number associated with the graphical object by interacting with the graphical object in the game.

5. The system of claim 1 wherein the random number generator produces cryptographically-strong sequences of unique random numbers within a specified numerical range.

6. The system of claim 1 wherein the bingo-style card has a plurality of attributes chosen from the list consisting of a count of columns, a count of rows, location of free spaces, a range of numbers that can appear in non-free spaces, and whether numbers in spaces are unordered or ordered.

7. The system of claim 1 wherein the at least one bingo-style card is assigned numbers by the random number generator or through user selection of numbers.

8. The system of claim 1 wherein the user terminal can only access the game server from within a defined geographical area.

9. A game administration system comprising:
a math server that associates at least one bingo-style card associated with a game instance object that is associated with a graphical depiction of the game that does not include a depiction of a bingo-style card, and that has a random number generator that generates a list of unique random numbers that are used as a ball drop, wherein the math server performs a bingo game using the at least one bingo-style card and ball drop to determine winners
a computer terminal that provides access to the math server;
a game configuration that defines a plurality of attributes of the bingo game selected from the list consisting of a format of the bingo-style car, the number of players allowed for a bingo game, the graphical depiction of the bingo game, the way progress in the bingo game is displayed through the graphical depiction of the bingo game, the maximum amount of money that can be wagered on the bingo game, the type of results that users can place wagers upon, the conditions for winning the bingo game, the geographical area in which the game may be played, and network protocols to allow access to the bingo game,
a game configuration editor accessible through the computer terminal;
an administrator interface generated by the game configuration editor allowing an administrator to create, edit and view game configurations stored in the bingo math server.

10. The system of claim 9 wherein the graphical depiction of the game is a horse race and wherein progress in the bingo game is correlated with progress in the graphical depiction of the horse race.

11. The system of claim 9 wherein the ball drop assigns numbers to a graphical object in the game and the user plays the number associated with the graphical object by interacting with the graphical object in the game.

12. The system of claim 9 wherein the bingo-style card has a plurality of attributes chosen from the list consisting of a count of columns, a count of rows, location of free spaces, a range of numbers that can appear in non-free spaces, and whether numbers in spaces are unordered or ordered.

13. The system of claim 9 wherein the at least one bingo-style card is assigned numbers by the random number generator or through user selection of numbers.

14. A method for running a bingo-style game, the method comprising the acts of:
providing at least one bingo-style card associated with a game instance object that is associated with a graphical depiction of the game that does not include a depiction of a bingo-style card;
providing a random number generator that generates a list of unique random numbers
using the list of unique number as a ball drop;
using the ball drop to determine at least one winner of the game;
displaying the graphical depiction of the game to the user on at least one user terminal.

15. The method of claim 14 wherein the graphical depiction of the game is a horse race and wherein progress in the bingo game is correlated with progress in the graphical depiction of the horse race.

16. The method of claim 14 further comprising assigning numbers to a graphical object in the game based on the ball drop and allowing the user to play the number associated with the graphical object by interacting with the graphical object in the game.

17. The method of claim 14 wherein the random number generator produces cryptographically-strong sequences of unique random numbers within a specified numerical range.

18. The method of claim 14 further comprising assigning a plurality of attributes to the bingo-style card chosen from the list consisting of a count of columns, a count of rows, location of free spaces, a range of numbers that can appear in non-free spaces, and whether numbers in spaces are unordered or ordered.

19. The method of claim 14 further comprising assigning numbers to the at least one bingo-style card by the random number generator or through user selection of numbers.

20. The method of claim 14 further comprising limiting access to the game service to a defined geographical area.
